(19) United States
(12) Patent Application Publication
(10) Pub. No.: US 2018/0314908 A1
(43) Pub. Date: Nov. 1, 2018

(54) METHOD AND APPARATUS FOR LABEL DETECTION

(71) Applicant: SYMBOL TECHNOLOGIES, LLC, Lincolnshire, IL (US)

(72) Inventor: Joseph Lam, North York (CA)

(21) Appl. No.: 15/583,786

(22) Filed: May 1, 2017

(51) Int. Cl. G06K 9/46; G06T 7/60

(52) U.S. Cl. CPC G06K 9/4671; G06T 7/60

(57) ABSTRACT

A method of label detection includes: obtaining a template for a label having a sub-region containing a visual feature, the template defining (i) a label geometry, and (ii) a sub-region geometry relative to the label geometry; obtaining an image; generating a feature mask from the image, the feature mask indicating areas of the image containing the visual feature; for each of a plurality of template positions within the feature mask, determining a score based on a degree of matching between the sub-region geometry and a respective subset of the areas; and selecting and presenting a label location within the image based on the scores.

### CROSS-REFERENCE TO RELATED APPLICATIONS

This application is related to U.S. Patent Application with Attorney Docket No. 151974US01, entitled “METHOD AND APPARATUS FOR EXTRACTING AND PROCESSING PRICE TEXT FROM AN IMAGE SET” by Zhang et al., as well as U.S. Provisional Patent Application No. 62/492,670 entitled “PRODUCT STATUS DETECTION SYSTEM” by Perrella et al., all having the same filing date as the present application. The contents of the above-referenced applications are incorporated herein by reference in their entirety.

### BACKGROUND

Environments in which inventories of objects are managed, such as products for purchase in a retail environment, may be complex and fluid. For example, a given environment may contain a wide variety of objects with different attributes (size, shape, price and the like). Further, the placement and quantity of the objects in the environment may change frequently. Still further, imaging conditions such as lighting may be variable both over time and at different locations in the environment. These factors may reduce the accuracy with which information concerning the objects may be collected within the environment.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a mobile automation system.

FIG. 2 is a block diagram of certain internal hardware components of the server in the system of FIG. 1.

FIG. 3 is a flowchart of a method of label detection.

FIG. 4 illustrates templates for two label types.

FIG. 5 is an image obtained for analysis via the method of FIG. 3.

FIG. 6 is a feature mask generated from the image of FIG. 5 via the method of FIG. 3.

FIGS. 7A-7B illustrate the determination of scores in the performance of the method of FIG. 3 employing the feature mask of FIG. 6 and the templates of FIG. 4.

FIG. 8 illustrates template variants for one of the templates of FIG. 4.

FIG. 9 illustrates a score heat map generated via the method of FIG. 3.

FIG. 10 is an output image from the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In retail environments in which a plurality of products are supported on shelves, labels may be placed on the shelf edges, the products, or a combination thereof, displaying information about the products. The information may include price, product name, barcodes encoding product identifiers, and so on. Systems configured to autonomously detect product status (e.g. to detect when a product is out of stock, whether the product's labeled price matches the reference price employed at point-of-sale terminals, and so on) may be required to identify the label for a product in an image of a shelf. However, the shelf images typically depict a number of distinct products, each of which bears various text and graphic information, as well as the labels. These other elements complicate the task of autonomously identifying the labels in the image. Imaging artifacts (lighting levels, reflections, and the like) may also complicate the task of machine vision systems in identifying labels in shelf images. Further, the above-mentioned labels may have a variety of different dimensions and formats (arrangement of data, color, and so on), such that a number of distinct types of labels are deployed within a single environment.

Examples disclosed herein are directed to a method of label detection including: obtaining a template for a label having a sub-region containing a visual feature, the template defining (i) a label geometry, and (ii) a sub-region geometry relative to the label geometry; obtaining an image; generating a feature mask from the image, the feature mask indicating areas of the image containing the visual feature; for each of a plurality of template positions within the feature mask, determining a score based on a degree of matching between the sub-region geometry and a respective subset of the areas; and selecting and presenting a label location within the image based on the scores.

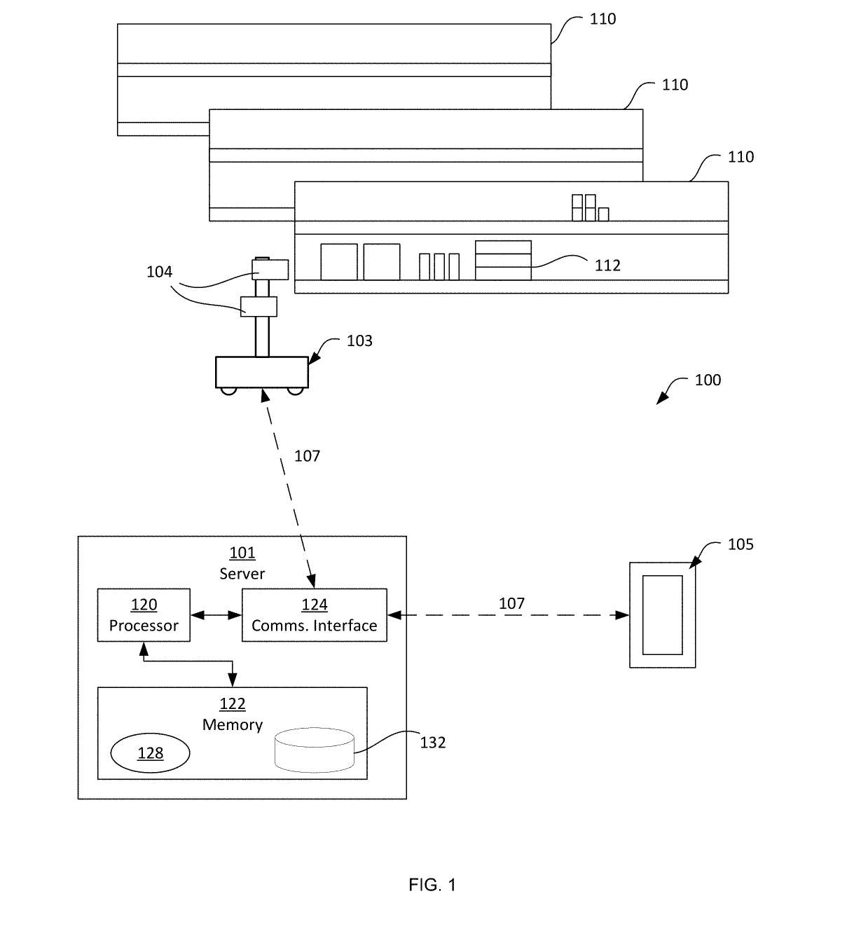

FIG. 1 depicts a mobile automation system 100 in accordance with the teachings of this disclosure. The system 100 includes a server 101 in communication with at least one mobile automation apparatus 103 (also referred to herein simply as the apparatus 103) and at least one mobile device 105 via communication links 107, illustrated in the present example as including wireless links. The system 100 is deployed, in the illustrated example, in a retail environment including a plurality of shelf modules 110 each supporting a plurality of products 112. The shelf modules 110 are typically arranged in a plurality of aisles, each of which includes a plurality of modules aligned end-to-end. More specifically, the apparatus 103 is deployed within the retail environment, and communicates with the server 101 (via the link 107) to navigate, either fully or partially autonomously, the length of at least a portion of the shelves 110. The apparatus 103 is equipped with a plurality of navigation and data capture sensors 104, such as image sensors (e.g. one or more digital cameras) and depth sensors (e.g. one or more Light Detection and Ranging (LIDAR) sensors), and is further configured to employ the sensors to capture shelf data. In the present example, the apparatus 103 is configured to capture a series of digital images of the shelves 110, as well as a series of depth measurements, each describing the distance and direction between the apparatus 103 and one or more points on a shelf 110, such as the shelf itself or the product disposed on the shelf.

The server 101 includes a special purpose imaging controller, such as a processor 120, specifically designed to control the mobile automation apparatus 103 to capture data, obtain the captured data via the communications interface 124 and store the captured data in a repository 132 in the memory 122. The server 101 is further configured to perform various post-processing operations on the captured data and to detect the status of the products 112 on the shelves 110. When certain status indicators are detected by the imaging processor 120, the server 101 is also configured to transmit status notifications (e.g. notifications indicating that products are out-of-stock, low stock or misplaced) to the mobile device 105. The processor 120 is interconnected with a non-transitory computer readable storage medium, such as a memory 122, having stored thereon computer readable instructions for executing label detection, as discussed in further detail below. The memory 122 includes a combination of volatile (e.g. Random Access Memory or RAM) and non-volatile memory (e.g. read only memory or ROM, Electrically Erasable Programmable Read Only Memory or EEPROM, flash memory). The processor 120 and the memory 122 each comprise one or more integrated circuits. In an embodiment, the processor 120, further includes one or more central processing units (CPUs) and/or graphics processing units (GPUs). In an embodiment, a specially designed integrated circuit, such as a Field Programmable Gate Array (FPGA), is designed to perform the label detection discussed herein, either alternatively or in addition to the imaging controller/processor 120 and memory 122. As those of skill in the art will realize, the mobile automation apparatus 103 also includes one or more controllers or processors and/or FPGAs, in communication with the controller 120, specifically configured to control navigational and/or data capture aspects of the apparatus 103.

The server 101 also includes a communications interface 124 interconnected with the processor 120. The communications interface 124 includes suitable hardware (e.g. transmitters, receivers, network interface controllers and the like) allowing the server 101 to communicate with other computing devices—particularly the apparatus 103 and the mobile device 105—via the links 107. The links 107 may be direct links, or links that traverse one or more networks, including both local and wide-area networks. The specific components of the communications interface 124 are selected based on the type of network or other links that the server 101 is required to communicate over. In the present example, a wireless local-area network is implemented within the retail environment via the deployment of one or more wireless access points. The links 107 therefore include both wireless links between the apparatus 103 and the mobile device 105 and the above-mentioned access points, and a wired link (e.g. an Ethernet-based link) between the server 101 and the access point.

The memory 122 stores a plurality of applications, each including a plurality of computer readable instructions executable by the processor 120. The execution of the above-mentioned instructions by the processor 120 configures the server 101 to perform various actions discussed herein. The applications stored in the memory 122 include a control application 128, which may also be implemented as a suite of logically distinct applications. In general, via execution of the control application 128 or subcomponents thereof, the processor 120 is configured to implement various functionality. The processor 120, as configured via the execution of the control application 128, is also referred to herein as the controller 120. As will now be apparent, some or all of the functionality implemented by the controller 120 described below may also be performed by preconfigured hardware elements (e.g. one or more ASICs) rather than by execution of the control application 128 by the processor 120.

In the present example, in particular, the server 101 is configured via the execution of the control application 128 by the processor 120, to process image data captured by the apparatus 103 to identify portions of the captured data depicting labels associated with the products 112.

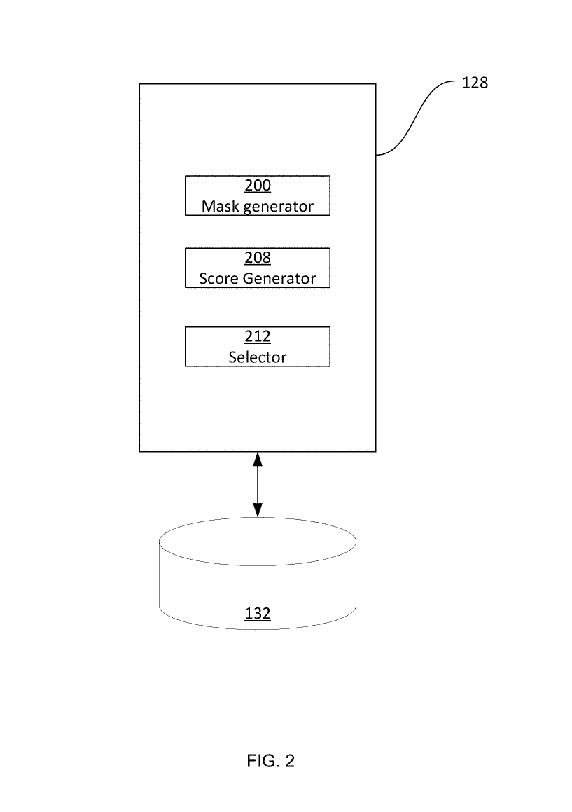

Turning now to FIG. 2, before describing the operation of the application 128 to identify labels from captured image data, certain components of the application 128 will be described in greater detail. As will be apparent to those skilled in the art, in other examples the components of the application 128 may be separated into distinct applications, or combined into other sets of components. Some or all of the components illustrated in FIG. 2 may also be implemented as dedicated hardware components, such as one or more Application-Specific Integrated Circuits (ASICs) or FPGAs. For example, in one embodiment, to improve reliability and processing speed, at least some of the components of FIG. 2 are programmed directly into the imaging controller 120, which may be an FPGA or an ASIC having circuit and memory configuration specifically designed to optimize image processing of a high volume of sensor data received from the mobile automation apparatus 103. In such an embodiment, some or all of the control application 128, discussed below, is an FPGA or an ASIC chip.

The control application 128 includes a mask generator 200 configured to obtain a shelf image depicting a portion of the shelves 110 and the products 112 supported thereon, and to generate one or more feature masks from the shelf image. The control application 128 also includes a score generator 208 configured to retrieve a template defining label geometry, and to generate a set of scores indicating a likelihood that each of a plurality of areas of the image contains a label, based on the above-mentioned feature masks. The control application 128 also includes a selector 212 configured to process the set of scores produced by the score generator 208 and select candidate regions of the image that are likely to depict labels.

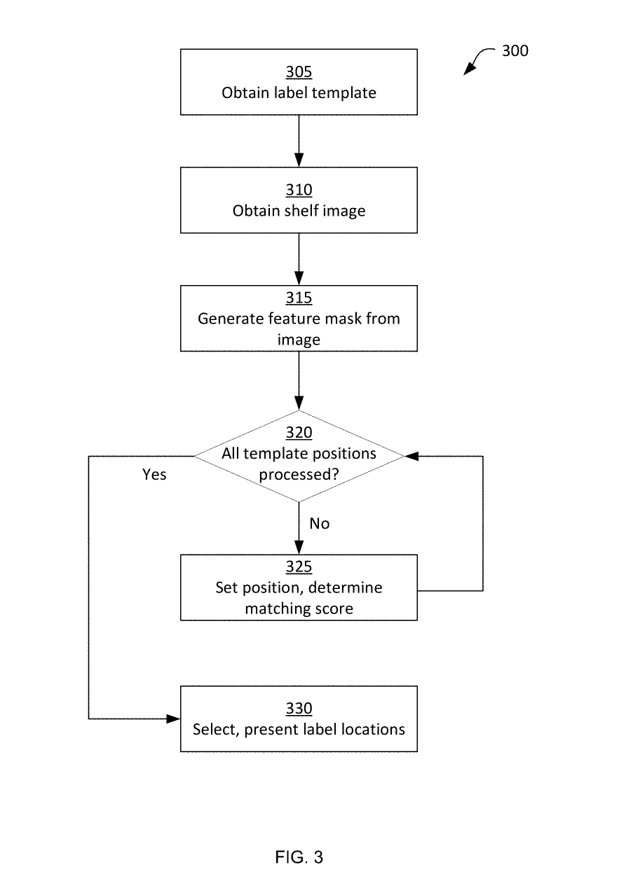

The functionality of the control application 128 will now be described in greater detail, with reference to the components illustrated in FIG. 2. Turning to FIG. 3, a method 300 of detecting labels in an image of a shelf is shown. The method 300 will be described in conjunction with its performance on the system 100 as described above.

At block 305, the control application 128 is configured to obtain a label template, for example from the repository 132. The label template, as will be discussed below in greater detail, is retrieved by the score generator 208 for use later in the performance of the method 300. The repository 132 stores one or more label templates, each of which defines a label geometry and at least one sub-region geometry corresponding to a sub-region of the label containing a visual feature, such as text (e.g. a price text string) or a barcode.

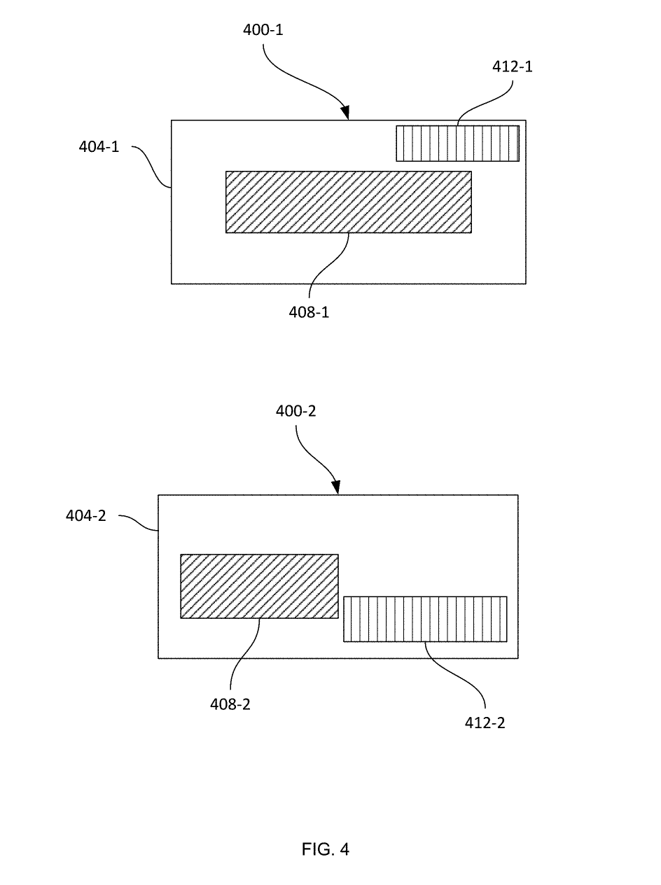

Turning to FIG. 4, two example templates 400-1 and 400-2 are illustrated, each corresponding to a distinct label format implemented in the retail or other environment in which the system 100 is deployed. Each template 400 is stored as an image file in the present example, and defines a label geometry 404-1, 404-2, illustrated as bounding boxes indicating the relative lengths of the label sides. The templates 400 can also include physical dimensions for the label geometries 404, for example in a separate data record or as metadata in the above-mentioned image file. Each template 400 also defines at least one sub-region geometry. In the present example, each template 400 defines two sub-region geometries, each corresponding to a different type of visual feature. As will be apparent, labels typically include a variety of visual features, such as price text strings, product names, barcodes, and the like. The sub-region geometries of the templates 400 define the expected positions and sizes of certain visual features relative to the label geometries 404.

More specifically, the template 400-1 includes a first sub-region geometry 408-1 corresponding to a price text string visual feature, and a second sub-region geometry 412-1 corresponding to a barcode visual feature. The sub-region geometries 408-1 and 412-1 indicate the relative size and position of the corresponding visual features within the label geometry 404-1. The template 400-2 also includes a first sub-region geometry 408-2 corresponding to a price text string visual feature, and a second sub-region geometry 412-2 corresponding to a barcode visual feature. The sub-region geometries 408-1 and 412-1 indicate the relative size and position of the corresponding visual features within the label geometry 404-2. As also illustrated in FIG. 4, the sub-region geometries are encoded in the image file to distinguish between the corresponding visual features. In the present example, the sub-region geometries 408 are encoded with a first intensity value—or any other suitable sub-region type indicator (illustrated with a first hatching pattern in FIG. 4)—while the sub-region geometries 412 are encoded with a second intensity value or other suitable sub-region type indicator (illustrated with a second hatching pattern in FIG. 4).

As will now be apparent, additional templates 400 can be stored in the repository 132, defining geometries for additional label formats. Further, each template 400 can include a smaller or larger number of sub-region geometries, and the sub-region geometries need not represent price text and barcode visual features. In some examples, sub-region geometries represent logos or other information appearing on labels, instead of or in addition to the text and barcode features mentioned above.

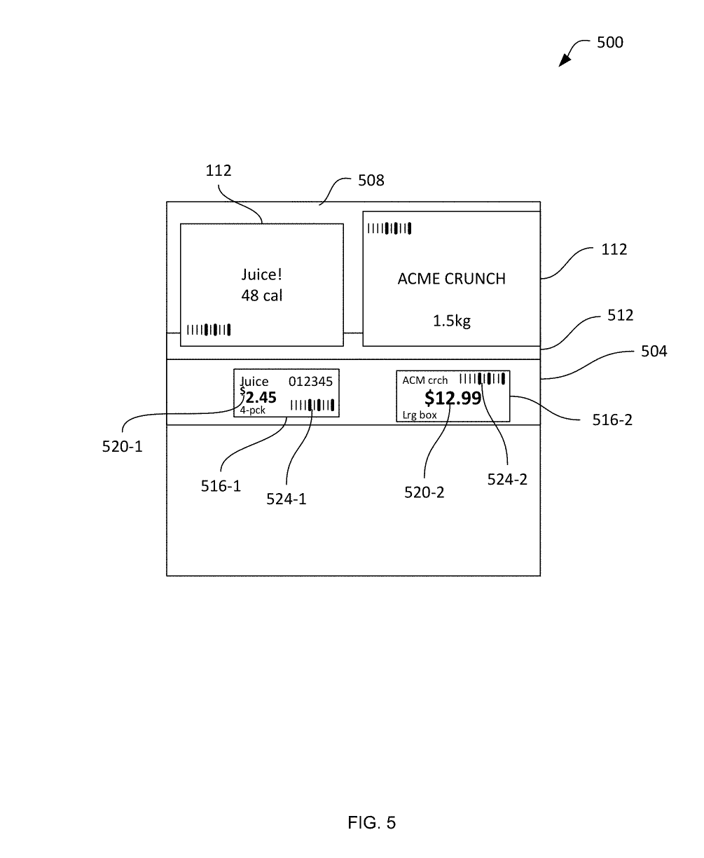

Returning to FIG. 3, at block 310, the mask generator 200 is configured to obtain a digital image of the shelf 110, for example captured by the apparatus 103 and stored in the repository 132. An example image 500 is illustrated in FIG. 5, depicting a portion of a shelf 110. In particular, the image 500 depicts shelf structure, such as a shelf edge 504 (e.g. an elongated rectangular, substantially vertical, surface facing an aisle in which the shelf is located) of a given shelf, and a shelf back 508 disposed at a back end of the shelf, as well as a support surface 512 extending the between the shelf edge 504 and the shelf back 508 and supporting products 112. In some examples, the support surface 512 and the shelf edge 504 are the top and front surfaces, respectively, of a shelf member attached to the shelf back 508. In addition, the image 500 depicts labels 516-1 and 516-2 that each include various visual features including price text strings 520-1 and 520-2 and barcodes 524-1 and 524-2. As will be apparent from FIG. 5, the labels 516 also have different formats (i.e. the visual elements of the label 516-1 have different positions and sizes in comparison with those of the label 516-2). As will also be apparent from FIG. 5, the products 112 themselves also bear visual elements such as text and barcodes. The mask generator 200 is also configured, in some examples, to downsample the image obtained at block 310, to reduce the computational burden of the remainder of the method 300. When the image is downsampled, the template 400 can also be downsampled.

Referring again to FIG. 3, at block 315, the mask generator 200 is configured to generate a feature mask from the image 500. The feature mask indicates areas of the image 500 that contain candidate visual features corresponding to the sub-region geometries in the templates 400. In other words, in the present example the feature mask indicates areas of the image 500 that are likely to depict one of text strings and barcodes. To generate the feature mask, the mask generator 200 is configured to apply one or more feature detection operations to the image 500. In the present example, the mask generator 200 is configured to apply a blob detection operation, such as a maximally stable extremal regions (MSER) operation, to the image 500 to identify elements in the image 500 likely to be characters of text. Other suitable text-detection operation can be performed instead of, or in addition to, MSER.

Further, the mask generator 200 is configured to apply a suitable barcode-detection operation to the image 500. In the present example, the mask generator 200 is configured to detect areas of the image 500 likely to contain barcodes by applying a series of operations. In particular, the mask generator 200 is configured to determine horizontal and vertical gradients for each pixel in the image 500, based on adjacent pixel intensities.

The mask generator 200 is then configured to construct a barcode mask in which each pixel is the difference between the horizontal and vertical gradients for the corresponding pixel of the image 500 (i.e. the vertical gradients subtracted from the horizontal gradients, and the result converted to an intensity value). As will be apparent from the barcodes shown in FIG. 5, the vertical gradients are not expected to be significant for linear barcodes, while the horizontal gradients are expected to vary substantially over the width of the barcode. Further, areas of the image 500 that do not contain barcodes are more likely to have horizontal and vertical gradients of similar magnitudes, and thus the above-mentioned subtraction will tend to result in low or zero intensities corresponding to the areas of the image 500 that do not depict barcodes, while resulting in elevated intensities for areas of the image 500 that do depict barcodes.

The mask generator 200 is then configured to apply a set of operations to the resulting barcode mask to eliminate areas of elevated intensities that are not likely to correspond to barcodes in the image 500. In the present example, the mask generator 200 is configured to apply first a smoothing operation to the barcode mask, followed by a binarization operation and one or more morphological operations. The morphological operations, in this example, include erosion followed by dilation. As will be apparent to those skilled in the art, erosion overlays a structuring element, such as a rectangular window, over the barcode mask at a plurality of positions, and sets the pixel centered underneath the structuring element to a low intensity (e.g. zero) unless all pixels underneath the structuring element have a high intensity (e.g. one). The process thus erodes the edges of contiguous areas of high intensity, and tends to remove small areas of high intensity, which are likely to be noise (rather than barcodes, in this application). Dilation also applies a structuring element to the barcode mask, but sets the central pixel to a high intensity if at least one pixel under the structuring element has a high intensity. Thus, dilation tends to increase the size of contiguous areas of high intensity that remain after erosion. As a result, the barcode mask includes boxes of uniform intensity at the locations of likely barcodes. The locations of such boxes are determined and added to the feature mask (following which the barcode mask may be discarded).

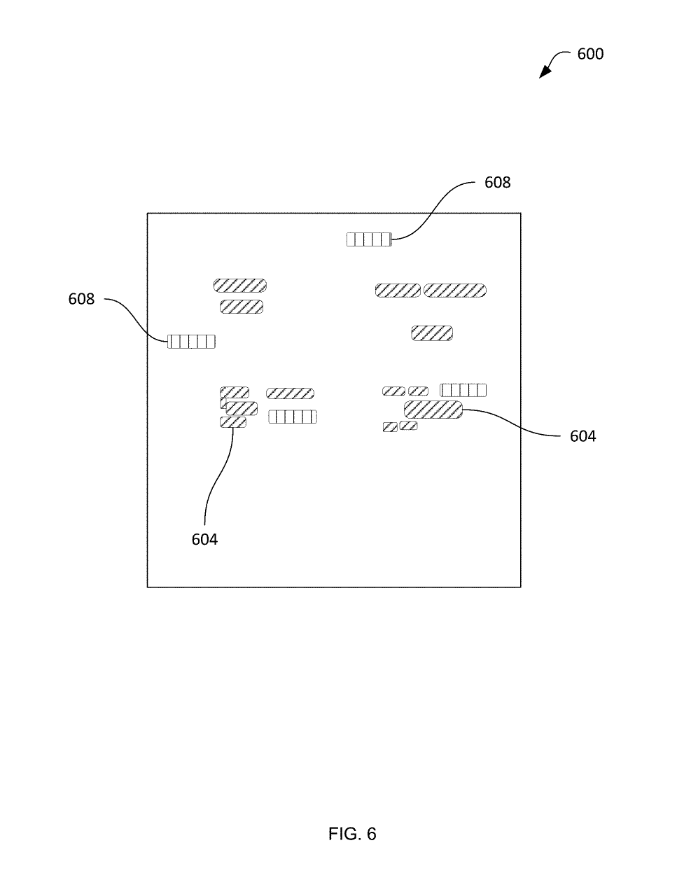

Referring to FIG. 6, a feature mask 600 is depicted, as generated from the image 500. As seen in FIG. 6, the feature mask 600 includes a plurality of areas 604 indicating locations within the image 500 that are likely to contain text, and a plurality of areas 608 indicating locations within the image 500 that are likely to contain barcodes. As will be apparent, it is not necessary for the mask generator 200 to interpret any text strings, or decode any barcodes. As will also be apparent, additional areas 604 and 608 may also be detected in some examples that do not align with text or barcodes in the image 500 (i.e. some areas 604 and 608 may be false positive detections).

The feature mask 600 distinguishes between the different visual features identified in the label templates 400. The areas corresponding to each visual feature are assigned different intensities in some examples (as illustrated by the different styles of hatched lines in FIG. 6). In other examples, the indication of which type of visual feature an area 604 or 608 corresponds to is stored as metadata within the feature mask 600. In still other examples, the feature mask 600 can include a distinct layer for each visual feature under consideration.

Responsive to generation of the feature mask 600, the score generator 208 is configured to generate a score based on a degree of matching between the sub-region geometries of a template 400 and respective subsets of the areas 604 and 608. Specifically, at block 320 the score generator 208 is configured to determine whether each of a plurality of template positions relative to the feature mask 600 have been processed. When the determination is negative, the score generator 208 proceeds to block 325, at which the score generator 208 is configured to select one of the templates retrieved at block 305 (if more than one template type was retrieved), and set a position for the template relative to the feature mask 600. It is also contemplated that template retrieval (block 305) is performed at this point, rather than before block 310 in some examples.

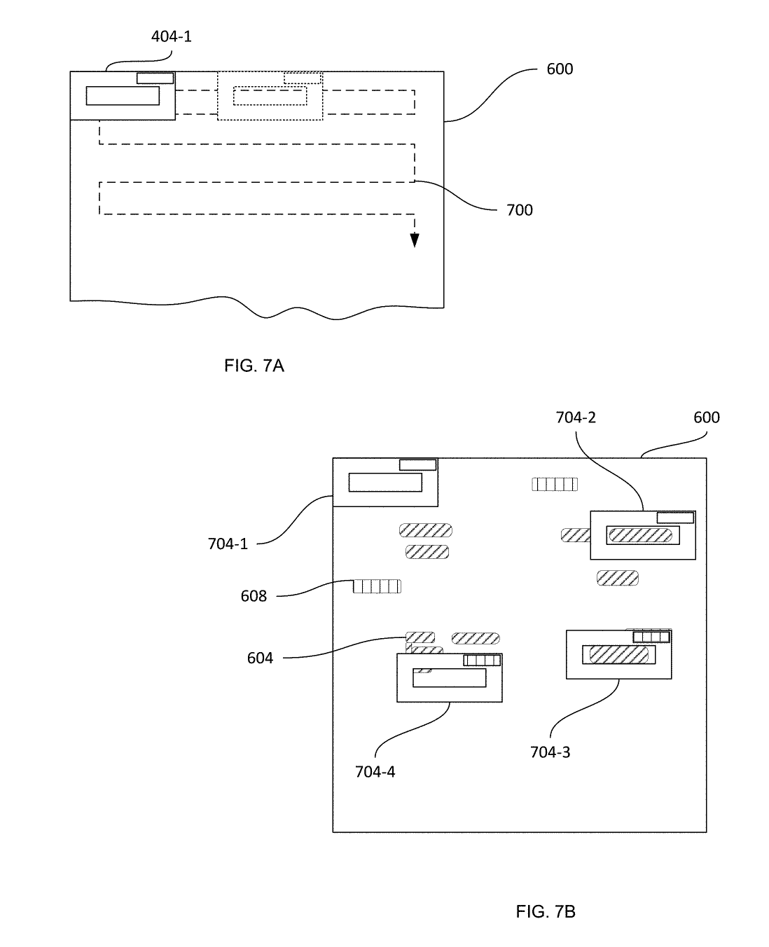

FIG. 7A illustrates a portion of the feature mask 600 with the template 404-1 overlaid in a first position for score generation. The score generator 208 is configured to determine a matching score for the template 404-1 at each of a plurality of positions. The positions are shown by a path 700 in FIG. 7A, which has been simplified for the purposes of illustration. As will be apparent, each position overlaps with adjacent positions. In the present example, each position is shifted from the previous position along the path 700 by a distance of one pixel. In other examples, greater spacing is implemented between template positions, at the cost of reduced scoring density. Further, a variety of other path configurations can also be implemented; in general, any set of positions that provides substantially complete coverage of the feature mask 600 is employed to generate scores.

At block 325, the score generator 208 is configured to generate a score for the template position. In the present example the score generator 208 determines a score based on a degree of overlap between the template sub-region geometries and the subset of the features in the feature mask that coincide with the template position. The degree of overlap is defined, in this example, as a fraction (e.g. expressed as a percentage or a decimal value between zero and one) of the sub-geometries 408 of the template 400 that overlap with corresponding visual features on the mask 600. Therefore, in the present example performance, referring to FIG. 7B, the score generator 208 determines a score for the template position 704-1 by determining the proportion of the text sub-geometry 408-1 that coincides with text features 604 in the mask 600, as well as the proportion of the barcode sub-geometry 412-1 that coincides with barcode features 608 in the mask 600. As seen in FIG. 7B, in the position 704-1 the template sub-geometries do not overlap with any features of the mask 600. The score for the position 704-1 is therefore zero.

Responsive to determining the score at a given template position, the score generator 208 is configured to return to block 320 and determine whether any template positions remain to be processed (i.e. scored). The performance of blocks 320 and 325 therefore repeats until all positions for each template 400 have been scored. Referring again to FIG. 7B, three additional example positions are illustrate for the template 404-1. At the position 704-2, a substantial portion (e.g. 90%) of the text sub-geometry 408-1 is matched with a text feature 604. However, the barcode sub-geometry 412-1 is not matched with any barcode features 608 of the mask 600. The score generator 208 is configured to generate partial scores for each sub-geometry, and to then combine the scores, for example by averaging them. In other examples, the scores can be weighted based on the relative sizes of the sub-geometries 408 and 412. For the position 704-2, the partial score for the sub-geometry 412-1 is zero, and the combined score is therefore the average of zero and 90%, or 45%.

By a process similar to that described above, the processing of the position 704-4 yields a partial score of 7% for the text sub-geometry 408-1 and a partial score of 100% for the barcode sub-geometry 412-1, for a combined score of 53.5%. Further, the processing of the position 704-3 yields a partial score of 85% for the text sub-geometry 408-1 and a partial score of 95% for the barcode sub-geometry 412-1, for a combined score of 90%.

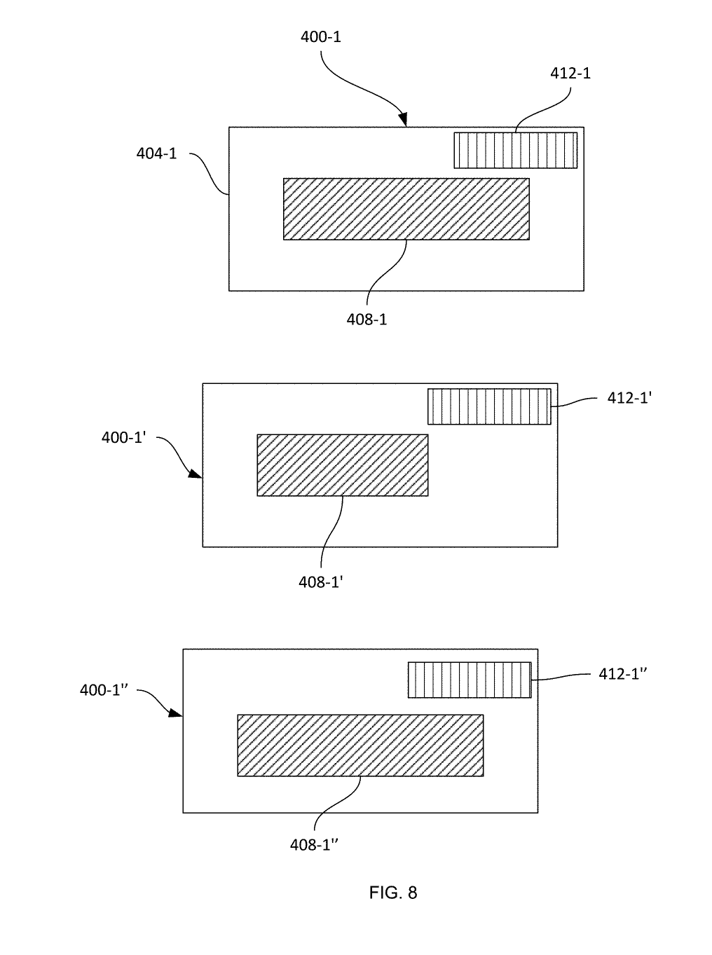

In some examples, the score generator 208 is also configured, at each position, to assess variations of the label sub-geometries 408 and 412. In particular, each template 400 can define a tolerance for the sub-geometries 408 and 412, expressed in any suitable manner. For example, a template 400 can include metadata indicating a degree (e.g. a percentage) by which the dimensions of each sub-geometry can be expanded or contracted. In other examples, the template 400 is implemented as a set of sub-templates, each defining variations of the sub-geometries. FIG. 8 illustrates the template 400-1 and two variants of the template 400-1, identified as templates 400-1′ and 400-1″ including respective sub-geometries 408-1′, 408-1″ and 412-1′, 412-1″. As seen in FIG. 8, the sub-geometry 408-1′ has a reduced width relative to the sub-geometry 408-1, and the sub-geometries 408-1″ and 412-1″ have similar sizes to the sub-geometries 408-1 and 412-1, but different positions within the template 400-1″.

The score generator 208, in examples employing template tolerance as described above, is configured to determine separate scores for each variant of a template 400 at a given position, and to select the highest of the variant-specific scores before proceeding to the next template position.

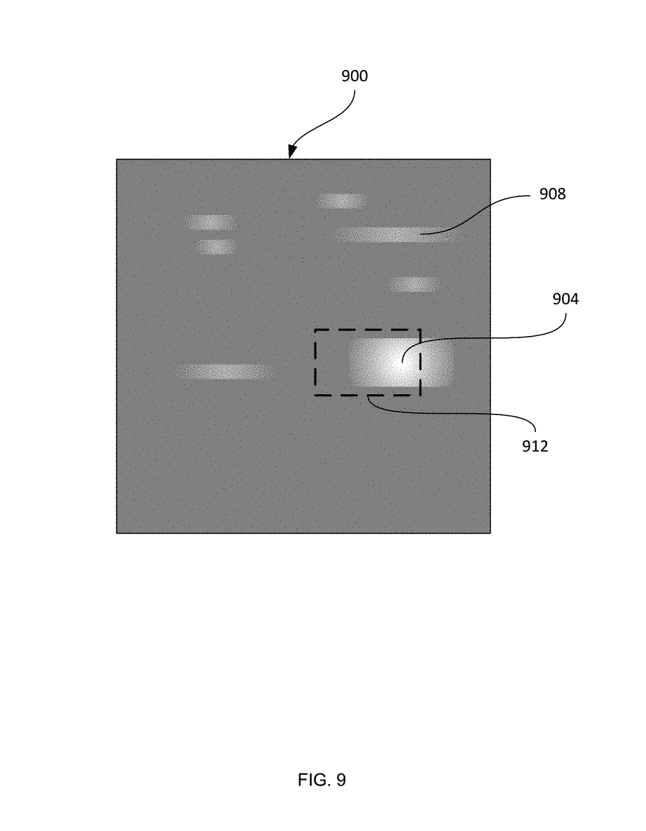

When the determination at block 320 is affirmative (i.e. when all positions for all templates 400 have been scored), the score generator 208 is configured to present the scores to the selector 212. The scores are presented, in this example, as a heat map image in which each pixel defines the score for a template position centered on that pixel. As will be apparent, when more than one template is processed, one heat map is produced for each template. FIG. 9 illustrates a simplified heat map 900 generated from the feature mask 600 for the template 400. Each point of the heat map 900 contains a score determined at block 325, indicating the degree to which the feature mask 600 matches the template 400 at a position centered on that point. For example, the point 904 shown in FIG. 9 has a score of 0.9, while the point 908 has a score of 0.4. As will also be apparent, the heat map 900 has the same size as the feature mask 600, and therefore includes scores for template positions centered near the edges of the feature mask 600. Such scores may be simply set to zero, or the template positions may be selected to include positions that are only partly contained within the feature mask.

At block 330, the selector 212 is configured to select one or more label locations based on the heat map 900. In the present example, the selector 212 is configured to apply a threshold (e.g. 80%) to the heat map 900, and set any scores that do not meet the threshold to a low intensity (e.g. zero). The selector 212 is then configured to select local maxima for each a plurality of windows subdividing the heat map; any suitable number, size and position of windows may be employed. For example, a window 912 is illustrated in FIG. 9, in which it will be apparent that the point 904 is selected as the local maximum within the window 912. Having selected local maxima from the heat map 900 following application of the threshold, the selector 212 is configured to generate and present label locations within the image 500, corresponding to the selected local maxima (i.e. the highest scores in the heat map 900 that remain after application of the threshold).

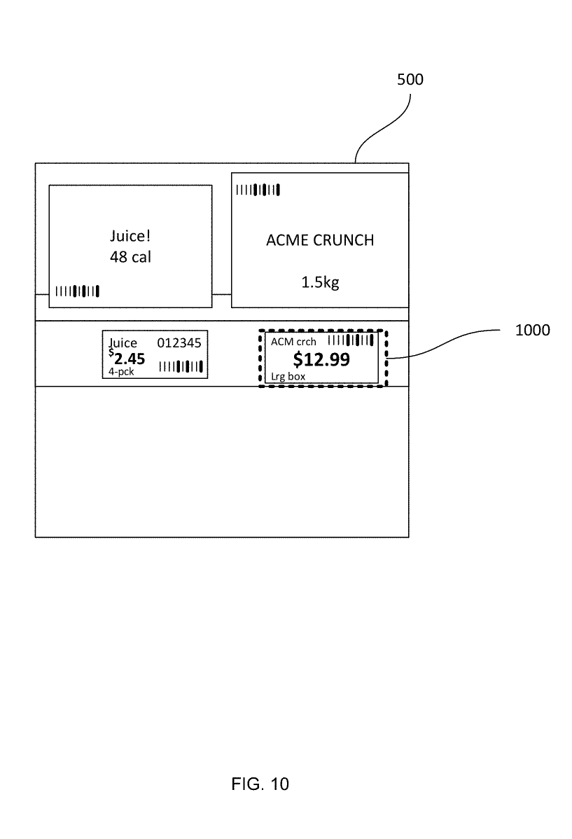

FIG. 10 illustrates the image 500 with a bounding box 1000 overlaid thereon by the selector 212. The bounding box has dimensions corresponding to those of the template 400-1 and is centered on the highest local score in the heat map 900. In the present example, no other areas of the heat map 900 are sufficiently highly scored to exceed the above-mentioned threshold. In examples in which multiple heat maps are generated (for multiple templates), the label locations are combined in a single overlay on the image 500.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of label detection by an imaging controller, comprising:
obtaining a template for a label having a sub-region containing a visual feature, the template defining (i) a label geometry, and (ii) a sub-region geometry relative to the label geometry;
obtaining an image;
generating a feature mask from the image, the feature mask indicating areas of the image containing the visual feature;
for each of a plurality of template positions within the feature mask, determining a score based on a degree of matching between the sub-region geometry and a respective subset of the areas; and
selecting and presenting a label location within the image based on the scores.

2. The method of claim 1, wherein determining a score comprises:
generating a score heat map corresponding to the image, the score heat map containing, for each of the positions, the score determined for that position.

3. The method of claim 2, wherein the selecting includes identifying respective local maxima within the score heat map for each of a plurality of windows within the heat map.

4. The method of claim 2, wherein the selecting includes applying a threshold to the scores.

5. The method of claim 1, wherein the presenting comprises:
presenting the image on a display, overlaid with a bounding box indicating the label location.

6. The method of claim 1, wherein the visual feature includes at least one of text and a barcode.

7. The method of claim 1, the template defining a plurality of sub-region geometries relative to the label geometry.

8. The method of claim 7, the template further defining a tolerance for each of the sub-region geometries relative to the label geometry; wherein determining the score for each of the template positions comprises:
selecting a plurality of sub-region geometries according to the tolerance;
determining a degree of matching for each of the sub-region geometries; and
determining the score based on the greatest degree of matching for each sub-region geometry.

9. The method of claim 1, wherein the obtaining comprises:
obtaining the template and a further template defining (i) a further label geometry, and (ii) a further sub-region geometry relative to the further label geometry;
each of the template and the further template also defining a label type; and
repeating the determining, the selecting and the presenting for each of the templates.

10. A server for detecting labels, comprising:
a memory storing a template for a label having a sub-region containing a visual feature, the template defining (i) a label geometry, and (ii) a sub-region geometry relative to the label geometry; and
an imaging controller comprising:
a mask generator configured to:
obtain an image; and
generate a feature mask from the image, the feature mask indicating areas of the image containing the visual feature;
a score generator configured, for each of a plurality of template positions within the feature mask, to determine a score based on a degree of matching between the sub-region geometry and a respective subset of the areas; and
a selector configured to select and present a label location within the image based on the scores.

11. The server of claim 10, the score generator configured to determine a score by generating a score heat map corresponding to the image, the score heat map containing, for each of the positions, the score determined for that position.

12. The server of claim 11, the selector configured to identify respective local maxima within the score heat map for each of a plurality of windows within the heat map.

13. The server of claim 11, the selector further configured to apply a threshold to the scores.

14. The server of claim 10, the selector further configured to present the label locations by presenting the image on a display, overlaid with a bounding box indicating the label location.

15. The server of claim 10, wherein the visual feature includes at least one of text and a barcode.

16. The server of claim 10, the template defining a plurality of sub-region geometries relative to the label geometry.

17. The server of claim 16, the template further defining a tolerance for each of the sub-region geometries relative to the label geometry; the score generator further configured to determine the score for each of the template positions by:
selecting a plurality of sub-region geometries according to the tolerance;
determining a degree of matching for each of the sub-region geometries; and
determining the score based on the greatest degree of matching for each sub-region geometry.

18. The server of claim 10, the score generator further configured to:
prior to determining the score, obtain the template and a further template defining (i) a further label geometry, and (ii) a further sub-region geometry relative to the further label geometry; each of the template and the further template also defining a label type; and
repeat the determining, the selecting and the presenting for each of the templates.
